(19) United States
(12) Patent Application Publication
(10) Pub. No.: US 2006/0215105 A1
(43) Pub. Date: Sep. 28, 2006

(54) Liquid crystal display device with photo spacers

(75) Inventor: Kun-Hsing Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/091,975

(22) Filed: Mar. 28, 2005

(51) Int. Cl. G02F 1/1339

(52) U.S. Cl. 349/155

(57) ABSTRACT

A liquid crystal display device (10) includes a first substrate (11), a second substrate (19) opposite to the first substrate, a liquid crystal layer (17) interposed between the first and second substrates, a sealant (18) disposed between and at a peripheral region of the liquid crystal display device between the first and second substrates for sealing a space between the first and second substrates and the sealant, and a photo spacer pattern (15) having a plurality of photo spacers (151, 152, 153). The photo spacers are formed within the space and outside the sealant at peripheral portions of the first and second substrates. The photo spacers are provided to ensure that the liquid crystal display device has a consistent cell gap.

### BACKGROUND OF THE INVENTION

1. Field of the Invention

The present invention relates to liquid crystal display (LCD) devices, and more particularly to an LCD device having photo spacers between substrates thereof.

2. Description of the Prior Art

An LCD device has the advantages of portability, low power consumption, and low radiation, and has been widely used in various portable information products such as notebooks, personal digital assistants (PDAs), video cameras and the like. Furthermore, the LCD device is considered by many to have the potential to completely replace CRT (cathode ray tube) monitors and televisions.

In a conventional TFT-LCD (thin film transistor liquid crystal display) device, spacers are provided between two substrates of the device to maintain a cell gap between the substrates. The spacers may be plastic beads, glass beads, or glass fibers. Generally, the spacers are sprayed or otherwise distributed onto one of the substrates during manufacturing of the device. The spacers are used to keep the cell gap consistent, so as to ensure that the device performs accurately and reliably. However, many or most of the spacers are disposed in the regions used for transmitting light. These spacers cause light scattering, which is liable to generate white point defects. Thus the contrast and the display performance of the device are impaired. For this reason, photo spacers formed by a photolithographic process have been developed to replace conventional plastic beads. Dimensions and positions of the photo spacers are configured to avoid affecting the transmission of light, while at the same time ensuring a uniform cell gap. Thus the display performance of the device is enhanced.

Taiwan Pat. No. 507,095, issued on Oct. 21, 2002, discloses an LCD device having photo spacers. Referring to FIG. 7, a schematic, exploded isometric view of the LCD device 17 is shown. In making the LCD device 17, firstly, a color pixel layer 174 and a black matrix layer 175 are provided on a color filter substrate 171. A photo spacer region 176 is formed on a peripheral region of the color filter substrate 171. The photo spacer region 176 is located at the outside of the black matrix color pixel layers 175, 174, and is separated from the black matrix layer 175 a predetermined distance. Secondly, a sealant 177 is formed on a TFT substrate 179. The sealant 177 is located opposite to an outside of the photo spacer region 176. Drops of liquid crystal 178 are dispensed onto the TFT substrate 179 one by one. Then the color filter substrate 171 is pressed face-to-face onto the TFT substrate 179 under vacuum, and the sealant 177 is cured by applying ultraviolet light thereto. The color filter substrate 171 and the TFT substrate 179 are thus engaged together, and the assembly constitutes the LCD device 17.

As seen in FIG. 7, the sealant 177 and the black matrix and color pixel layers 175, 174 are separated by the photo spacer region 176. When ultraviolet light is applied from a top side of the color filter substrate 171, the black matrix layer 175 does not interfere with the irradiation of the sealant 177. In other words, there are no light shielding problems, and the sealant 177 can be completely cured. Moreover, during the curing process, the sealant 177 does not contact the liquid crystal 178, and the liquid crystal 178 does not become soiled or damaged.

However, the photo spacer region 176 is only formed on a rectangular region of the color filter substrate 171 outside the black matrix and color pixel layers 175, 174. Inmost portions of the black matrix and color pixel layers 175, 174, and a peripheral region outside the sealant 177, are not directly supported by the photo spacer region 176. Therefore the distance between the substrates 171, 179 may not be uniform. That is, the LCD device 17 may not have a consistent cell gap, and thus have impaired display characteristics.

It is desired to provide an improved LCD device which overcomes the above-described deficiencies.

### SUMMARY OF THE INVENTION

An object of the present invention is to provide an LCD device with a consistent, reliable cell gap.

In order to achieve the object set out above, an LCD device in accordance with the present invention includes a first substrate, a second substrate opposite to the first substrate, a liquid crystal layer interposed between the first and second substrates, a sealant disposed at a peripheral region of the liquid crystal display device between the first and second substrates for sealing a space between the first and second substrates and the sealant, and a photo spacer pattern having a plurality of photo spacers. The photo spacers are disposed within the space and outside the sealant at peripheral portions of the first and second substrates.

Unlike in a conventional LCD device, the photo spacers according to the present invention are formed not only within the space but also outside the sealant at a peripheral portion between the substrates. This configuration ensures that the LCD device has a consistent cell gap, and can therefore provide a steady, reliable display.

Other objects, advantages, and novel features of the present invention will become more apparent from the following detailed description when taken in conjunction with the accompanying drawings.

### BRIEF DESCRIPTION OF THE DRAWINGS

FIG. 1 is a schematic, side cross-sectional view of an LCD device according to a first embodiment of the present invention.

FIG. 2 is a schematic, top plan view of a configuration relating to a substrate of the LCD device of FIG. 1.

FIG. 3 is a schematic, side cross-sectional view of an LCD device according to a second embodiment of the present invention.

FIG. 4 is a schematic, side cross-sectional view of an LCD device according to a third embodiment of the present invention.

FIG. 5 is a schematic, top plan view of a configuration relating to a substrate employed in an LCD device according to a fourth embodiment of the present invention.

FIG. 6 is a schematic, top plan view of a configuration relating to a substrate employed in an LCD device according to a fifth embodiment of the present invention.

FIG. 7 is a schematic, side cross-sectional view of a conventional LCD device.

### DETAILED DESCRIPTION OF THE PRESENT INVENTION

Reference will now be made to the drawings to describe the present invention in detail.

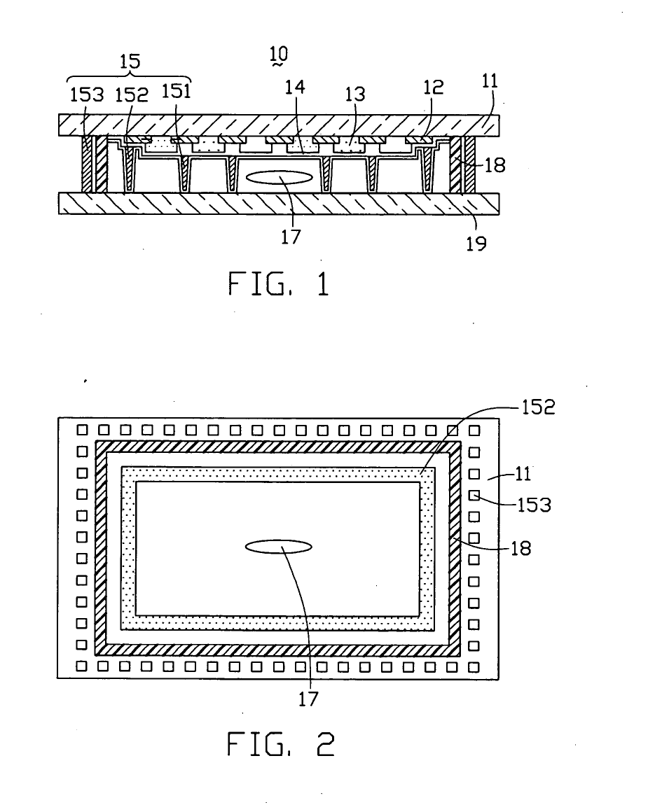

FIG. 1 is a schematic, side cross-sectional view of an LCD device 10 according to the first embodiment of the present invention. The LCD device 10 includes a transparent first substrate 11, a transparent second substrate 19 opposite to the first substrate 11, a liquid crystal layer 17 including liquid crystal molecules sandwiched between the substrates 11, 19, a sealant 18 disposed at a peripheral region between the substrates 11, 19 to engage the substrates 11, 19 together and seal a space therebetween, and a photo spacer pattern 15 disposed between the substrates 11, 19 for supporting the LCD device 10 and maintaining the space between the substrates 11, 19.

The first substrate 11 has a black matrix 12 having a plurality of recesses, a color layer 13 having a plurality of color resists filling in the recesses, and a transparent conductive layer 14 covering the color layer 13 and the black matrix 12.

The photo spacer pattern 15 comprises a plurality of photo spacers 151, 152, 153. A set of the photo spacers 151 and a continuous photo spacer 152 are disposed on the transparent conductive layer 14 within the space formed by the substrates 11, 19 and the sealant 18. The photo spacers 153 are disposed outside the sealant 18 at the peripheral region between the substrates 11, 19. The set of photo spacers 151 are formed as a plurality of discrete protrusions, which are disposed corresponding to the black matrix 12 in a display area of the LCD device 10. Also referring to FIG. 2, this is a schematic, top plan view of a configuration relating to the first substrate 11. The continuous photo spacer 152 is disposed adjacent and substantially parallel to the sealant 18, and is separated a distance from the sealant 18. The photo spacers 153 are formed as a plurality of discrete protrusions, which are periodically arranged around the sealant 18, and are spaced a same distance from the sealant 18.

The photo spacers 151, 152, 153 are made of a negative acrylic resin, and are formed by a photolithographic process. All the photo spacers 151, 152, 153 have lower surfaces for adhering to the second substrate 19, and all the lower surfaces are coplanar.

The second substrate 19 comprises a plurality of electrodes (not labeled), which are used for generating an electric field to drive the liquid crystal molecules.

The photo spacers 151, 152, 153 are disposed between and throughout expanses of the substrates 11, 19. This configuration ensures that the LCD device 10 has a consistent cell gap at a central display region and at a peripheral portion outside the sealant 18.

FIG. 3 is a schematic, side cross-sectional view of an LCD device 20 according to the second embodiment of the present invention. The LCD device 20 has a configuration similar to the LCD device 10 of the first embodiment. The LCD device 20 includes a photo spacer pattern 25 having a plurality of photo spacers 251, 252, 253, which are disposed at a central display region of the LCD device 20 and at a peripheral portion of the LCD device 20 outside a sealant 28. The photo spacer pattern 25 ensures that the LCD device 20 has a consistent cell gap. However, a substrate 21 of the LCD device 20 has no black matrix thereon, and a color layer 23 comprises a plurality of color resists of red (R), green (G), and blue (B) separately and alternately formed on a surface of the substrate 21. The set of photo spacers 251 are disposed as a plurality of individual protrusions corresponding to gaps between each two adjacent color resists. A width of the photo spacers 251 is larger than a width of the gaps. The photo spacers 25 are made of an acrylic resin, which has a high optical density similar to that of a black matrix such as the black matrix 12 employed in the LCD device 10. That is, in the LCD device 20, the black matrix is omitted, and the set of photo spacers 251 can be used for shielding light.

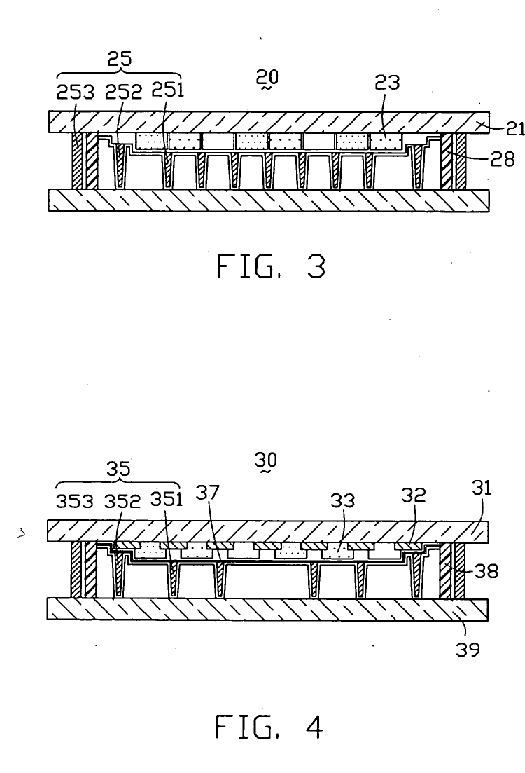

FIG. 4 is a schematic, side cross-sectional view of an LCD device 30 according to the third embodiment of the present invention. The LCD device 30 has a configuration similar to that of the LCD device 10 of the first embodiment. A sealant 38 is disposed at a peripheral region between two substrates 31, 39. An over coat layer 37 is coated on a black matrix 32 and a color layer 33. The over coat layer 37 is made of an acrylic resin, and is for providing the combined black matrix 32 and color layer 33 with a uniform thickness. A photo spacer pattern 35 having a plurality of photo spacers 351, 352, 353 is disposed between the substrates 31, 39. The photo spacer pattern 35 is for maintaining a uniform distance between the substrates 31, 39, which ensures that the LCD device 30 has a consistent cell gap. The set of photo spacers 351 is formed on the over coat layer 37.

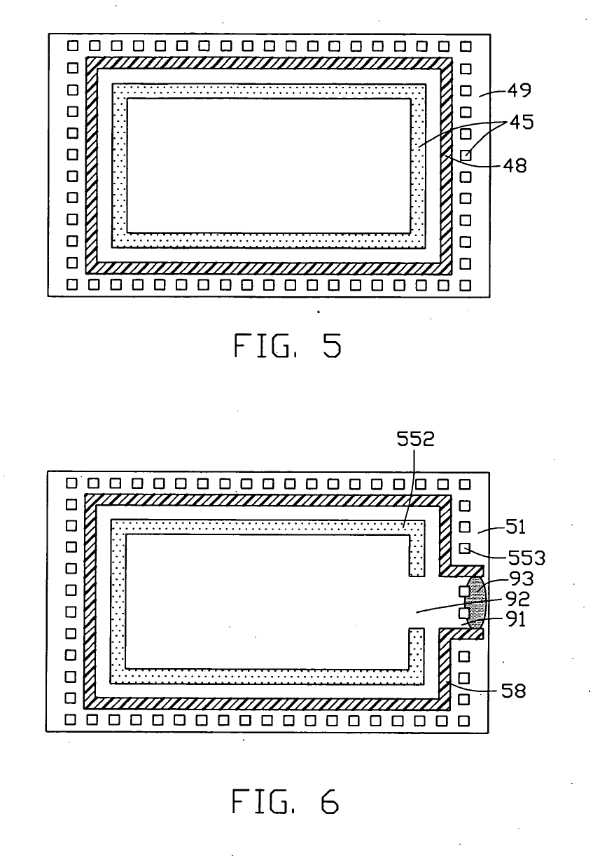

Referring to FIG. 5, this is a schematic, top plan view relating to a substrate 49 employed in an LCD device according to the fourth embodiment of the present invention. A sealant 48 is disposed on a peripheral region of a substrate 49. The substrate 49 comprises a TFT electrode layer and a color layer (not labeled), and is thus called a COA (color filter on array) substrate 49. A photo spacer pattern 45 is formed on the substrate 49. The photo spacer pattern 45 has a configuration similar to that of the photo spacer pattern 15 of the LCD device 10. After the substrate 49 is attached to another substrate (not shown), an LCD device having a consistent cell gap is obtained.

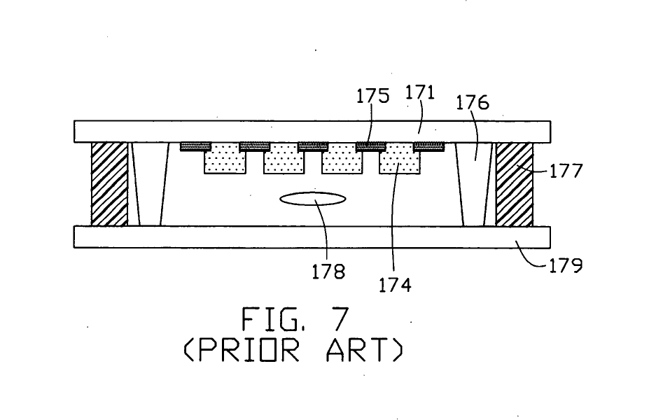

Referring to FIG. 6, this is a schematic, top plan view relating to a substrate 51 employed in an LCD device according to the fifth embodiment of the present invention. The substrate 51 is employed in an LCD device which, during fabrication, undergoes an injection process to fill a cell gap with liquid crystal molecules. The substrate 51 comprises a sealant 58, and a photo spacer pattern 55 having a plurality of photo spacers 552, 553 disposed at a central display region and at a peripheral region outside the sealant 58. The photo spacer pattern 55 is arranged in similar fashion to the photo spacer pattern 15 of the LCD device 10. The sealant 58 has a gap 91 in one side thereof. The photo spacer 552 has a gap 92, adjacent and corresponding to the gap 91. After assembling the substrate 51 and another substrate (not shown) to obtain an LCD panel preform, the gaps 91, 92 cooperatively form an opening at one side of the LCD panel. The opening is used for injecting liquid crystal molecules into the cell gap. During the process of curing an end seal 93 to seal the opening, the photo spacers 553 in the gap 91 are used as a stop that limits contact of the end seal 93 with the liquid crystal molecules in the cell gap. This helps prevent liquid crystal molecules from being soiled or damaged by material of the end seal 93. Further, the photo spacer pattern 55 ensures that the LCD device employing the substrate 51 has a consistent cell gap.

Unlike in a conventional LCD device, the photo spacers according to the present invention are formed not only within the space surrounded by the sealant, but also outside the sealant at peripheral portions of the substrates. This configuration ensures that the LCD device has a consistent cell gap, and can provide a steady, reliable display.

It is to be understood, however, that even though numerous characteristics and advantages of the present invention have been set out in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a first substrate;
a second substrate opposite to the first substrate;
a liquid crystal layer interposed between the first and second substrates;
a sealant disposed at a peripheral region of the liquid crystal display device between the first and second substrates, and sealing a space between the first and second substrates and the sealant; and
a photo spacer pattern having a plurality of photo spacers, which are provided within the space and outside the sealant at peripheral portions of the first and second substrates.

2. The liquid crystal display device as claimed in claim 1, wherein the photo spacers are made of a negative acrylic resin.

3. The liquid crystal display device as claimed in claim 1, wherein photo spacers within the space are formed as a plurality of discrete protrusions.

4. The liquid crystal display device as claimed in claim 3, wherein one of the substrates has a black matrix, and photo spacers within the space are disposed corresponding to the black matrix.

5. The liquid crystal display device as claimed in claim 3, wherein one of the substrates has a color layer comprising a plurality of color resists of red (R), green (G), and blue (B) separately and alternately formed on the substrate, and photo spacers within the space are disposed corresponding to gaps between each two adjacent color resists.

6. The liquid crystal display device as claimed in claim 3, wherein one of the substrates has an over coat layer, and photo spacers within the space are disposed on the over coat layer.

7. The liquid crystal display device as claimed in claim 3, wherein one of the substrates has a transparent conductive layer, and photo spacers within the space are disposed on the transparent conductive layer.

8. The liquid crystal display device as claimed in claim 1, wherein the photo spacer pattern comprises a continuous photo spacer disposed within the space adjacent to and separate from the sealant.

9. The liquid crystal display device as claimed in claim 8, wherein the sealant defines a gap, and the continuous photo spacer defines a gap corresponding to the gap of the sealant.

10. The liquid crystal display device as claimed in claim 1, wherein the photo spacer pattern comprises a plurality of discrete photo spacers periodically arranged around an outside of the sealant.

11. The liquid crystal display device as claimed in claim 10, wherein the outside photo spacers are formed as discrete protrusions.

12. The liquid crystal display device as claimed in claim 10, wherein the outside photo spacers are disposed separate and equally distant from the sealant.

13. A liquid crystal display device, comprising:
a first substrate;
a second substrate opposite to the first substrate;
a liquid crystal layer interposed between the first and second substrates;
a sealant disposed at a peripheral region of the liquid crystal display device between the first and second substrates, and sealing a space between the first and second substrates and the sealant; and
a photo spacer pattern;
wherein, the photo spacer pattern includes a set of photo spacers formed in a display area within the space, a continuous photo spacer formed adjacent to and separate from the sealant within the space, and a plurality of discrete photo spacers periodically arranged outside the sealant.

14. The liquid crystal display device as claimed in claim 13, wherein the set of photo spacers are formed as a plurality of discrete protrusions.

15. The liquid crystal display device as claimed in claim 13, wherein one of the substrates has a black matrix, and the set of photo spacers are disposed corresponding to the black matrix.

16. The liquid crystal display device as claimed in claim 13, wherein one of the substrates has a color layer comprising a plurality of color resists of red (R), green (G), and blue (B) separately and alternately formed on the substrate, and the set of photo spacers are disposed corresponding to gaps between each two adjacent color resists.

17. The liquid crystal display device as claimed in claim 13, wherein the sealant defines a gap, and the continuous photo spacer defines a gap corresponding to the gap of the sealant.

18. The liquid crystal display device as claimed in claim 13, wherein the outside photo spacers are disposed separate and equally distant from the sealant.

19. A liquid crystal display device, comprising:
a first substrate;
a second substrate opposite to the first substrate;
a liquid crystal layer interposed between the first and second substrates;
a sealant disposed at a peripheral region of the liquid crystal display device between the first and second substrates, and sealing a space between the first and second substrates and the sealant; and
a photo spacer pattern having a plurality of discrete photo spacers, which are provided outside the sealant at peripheral portions of the first and second substrates and support said first and second substrates respectively.
